(19) United States
(12) Patent Application Publication
(10) Pub. No.: US 2008/0144469 A1
(43) Pub. Date: Jun. 19, 2008

(54) DISC APPARATUS AND BCA SIGNAL REPRODUCTION METHOD USING THE APPARATUS

(75) Inventors: Hiroaki Morino, Tokyo (JP); Yukiyasu Tatsuzawa, Tokyo (JP); You Yoshioka, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/952,946

(22) Filed: Dec. 7, 2007

(30) Foreign Application Priority Data
Dec. 7, 2006 (JP) 2006-330852

(51) Int. Cl. G11B 7/00

(52) U.S. Cl. 369/53.31

(57) ABSTRACT

A BCA signal reproduction method for reading a BCA signal from a disc includes detecting a peak value of the BCA signal (peak detection value); detecting a bottom value of the BCA signal using a wide tracking bandwidth (first bottom detection value); detecting a bottom value of the BCA signal using a narrow tracking bandwidth (second bottom detection value); detecting a signal indicating whether the current portion is a no-signal portion where the BCA signal is not recorded or a signal portion where the BCA signal is recorded, on the basis of the peak detection value, the first bottom detection value, and the second bottom detection value; determining a slice level for binarizing the BCA signal on the basis of the detected signal and at least the peak detection value, the first bottom detection value, and the second bottom detection value; and binarizing the BCA signal.

### CROSS-REFERENCE TO RELATED APPLICATIONS

This application claims the benefit of priority of Japanese Patent Application No. 2006-330852, filed Dec. 7, 2006, the entire contents of which are incorporated herein by reference.

### BACKGROUND

1. Field

The present invention relates to reproduction of a signal from a digital versatile disc (DVD) and particularly relates to reproduction of a signal from a burst cutting area (BCA).

2. Description of the Related Art

An optical disc, such as a DVD, has an area called BCA in which a barcode-like pattern is recorded. BCA is a type of data recording area specified by DVD specifications. In a BCA of a DVD made by bonding two substrates together, long and thin stripes are radially formed with YAG laser or the like by partially removing a reflective coating of aluminum or the like at the inner radius of the DVD. The stripes are arranged along the innermost circumference of the DVD and thus make it possible to form a barcode-like signal. Therefore, a type of information which is different from that carried by a signal recorded as pits on a track of an optical disc can be recorded as a barcode-like signal in a BCA. For example, information such as a serial number of the disc can be recorded in the BCA.

Then, there has been proposed a technique for correctly reading a signal (BCA signal) from a BCA (see JP-A 11-328857, in particular, FIG. 1).

### SUMMARY OF THE INVENTION

JP-A 11-328857 discloses a technique in which a counter is used to perform signal detection after a BCA signal is binarized at a fixed slice level. In this case, however, a BCA signal cannot be properly binarized if a DC level is significantly changed by the presence of a defect such as a fingerprint, a track cross signal, or the like.

Additionally, there is a disc in which a wedge-shaped leading edge of noise is superimposed on a BCA mark. In this case, if a slice level overlaps with such a superimposed portion, a BCA signal may be processed as noise and cannot be correctly detected by counter processing alone.

The present invention has been made to solve the problems described above. An object of the present invention is to provide a disc apparatus and a BCA signal reproduction method implemented by the disc apparatus, which performs peak and bottom envelope detection at the time of binarizing a BCA signal, uses two different types of bottom envelope detection and switching of a slice level depending on the disc type, and thereby eliminates noise to output a binarized signal having a shaped waveform.

To solve the problems described above, a disc apparatus for reading a BCA signal from a disc on which a BCA is formed according to an aspect of the present invention includes a peak-envelope detection circuit configured to detect a peak value of the BCA signal; a first bottom-envelope detection circuit configured to detect a bottom value of the BCA signal; a second bottom-envelope detection circuit having a tracking bandwidth narrower than that of the first bottom-envelope detection circuit; a detection circuit configured to detect a signal indicating whether the current portion is a no-signal portion where the BCA signal is not recorded or a signal portion where the BCA signal is recorded, on the basis of a peak detection value detected by the peak-envelope detection circuit, a first bottom detection value detected by the first bottom-envelope detection circuit, and a second bottom detection value detected by the second bottom-envelope detection circuit; a slice-level detection circuit configured to determine a slice level for binarizing the BCA signal on the basis of the signal detected by the detection circuit and at least the peak detection value, the first bottom detection value, and the second bottom detection value; and a binarization circuit configured to binarize the BCA signal on the basis of the slice level determined by the slice-level detection circuit.

The present invention makes it possible not only to deal with variations in DC level due to the presence of a defect or the like, but also to deal with noise that is specific to each disc by changing the slice level depending on the type of the disc.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 illustrates a location of a BCA on a disc.

FIG. 2A illustrates a BCA waveform on which modulated data is superimposed. FIG. 2B illustrates a BCA waveform written on a mirror surface. FIG. 2C is an enlarged view of a BCA waveform on which modulated data is superimposed. FIG. 2D is an enlarged view of a BCA waveform written on a mirror surface.

FIG. 3 is a block configuration diagram of an optical disc apparatus according to an embodiment of the present invention.

FIG. 4A illustrates first bottom detection. FIG. 4B illustrates second bottom detection.

FIG. 5 is a flowchart of processing for detecting a no-signal portion.

FIG. 6A illustrates an amplitude determination based on a peak detection value and a first bottom detection value. FIG. 6B illustrates a bottom-up determination based on the first bottom detection value and a second bottom detection value.

FIG. 6C illustrates an amplitude determination based on the peak detection value and the first bottom detection value.

FIG. 6D illustrates a bottom-up determination based on the first bottom detection value and the second bottom detection value.

FIG. 7 is a flowchart of slice level determination processing.

FIG. 8 illustrates an example in which a slice level is changed by a slice level determination method.

FIG. 9 is a flowchart illustrating defect detection.

### DETAILED DESCRIPTION

Embodiments of the present invention will now be described in detail with reference to the drawings.

There are a variety of optical discs, including CDs, DVDs, blu-ray discs (BDs), and high-definition DVDs (HD DVDs), as well as read only memory (ROM) discs, recordable (R) discs, and rewritable (RW) discs. Each optical disc has a BCA in which information enabling a disc drive to identify the disc and copy protection information unique to the disc are written.

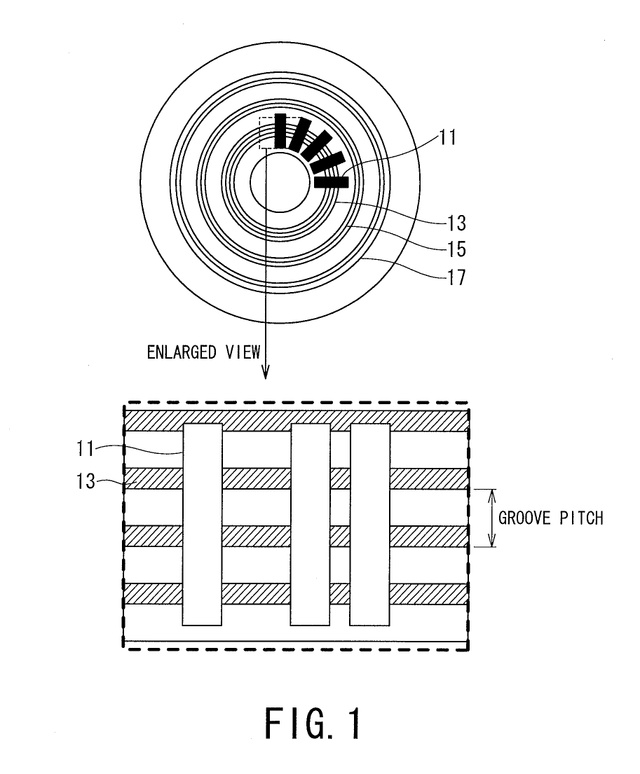

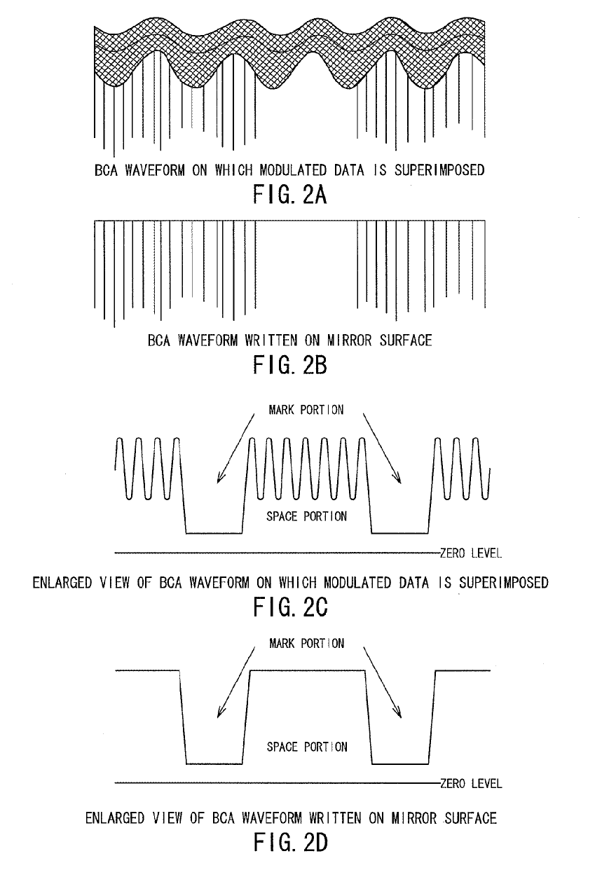

FIG. 1 illustrates a location of a BCA on a disc. FIG. 2A illustrates a BCA waveform on which modulated data is superimposed. FIG. 2B illustrates a BCA waveform written on a mirror surface. FIG. 2C is an enlarged view of a BCA waveform on which modulated data is superimposed. FIG. 2D is an enlarged view of a BCA waveform written on a mirror surface.

As illustrated in FIG. 1, a BCA 11 is formed in a radial direction of the disc in such a manner as to cross a plurality of grooves 13. A system lead-in area 15 is formed outside the BCA 11, and a data area 17 is formed further outside the system lead-in area 15. In a DVD-ROM and a DVD-RAM, since the BCA 11 is written over an area where modulated data (user data) is written, a high-frequency component signal is observed even in a portion where the BCA 11 is not written (see FIG. 2A and FIG. 2C).

On the other hand, in a DVD-R, a DVD-RW, and an HD DVD, since the BCA 11 is written on a mirror surface, a signal level in a portion where the BCA 11 is not written is kept substantially constant at a high level (see FIG. 2B and FIG. 2D).

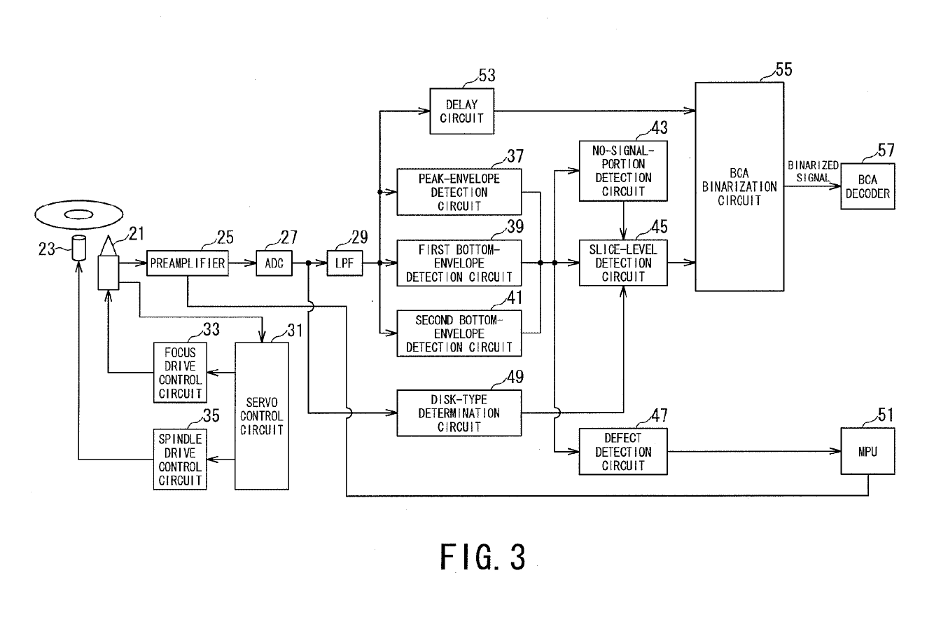

FIG. 3 is a block configuration diagram of an optical disc apparatus according to an embodiment of the present invention. First, an optical pickup 21 reads a signal from an optical disc and sends the read signal to a servo control circuit 31. Then, the servo control circuit 31 sends a focus control signal and a spindle control signal to a focus drive control circuit 33 and a spindle drive control circuit 35, respectively. The focus drive control circuit 33 performs focus adjustment on the basis of the focus control signal, while the spindle drive control circuit 35 adjusts the rotation speed of the disc (i.e., adjusts a spindle motor 23).

A preamplifier 25 receives a BCA signal from the optical pickup 21 and performs gain adjustment on the received BCA signal. The gain-adjusted BCA signal is AD-converted by an ADC 27. Then, a low-pass filter (LPF 29) removes high-frequency components of the BCA signal. The frequency components of a BCA waveform signal is lower than that of main data (user data). Therefore, high-frequency components irrelevant to the BCA are removed. After being AD-converted, the BCA signal is sent to a disc-type determination circuit 49. On the basis of the BCA signal, the disc-type determination circuit 49 outputs a disc-type determination signal.

The BCA signal from which high-frequency components have been removed by the LPF 29 is input to a peak-envelope detection circuit 37 configured to perform peak envelope detection, a first bottom-envelope detection circuit 39 configured to perform bottom envelope detection, and a second bottom-envelope detection circuit 41 having a tracking bandwidth narrower than that of the first bottom-envelope detection circuit 39.

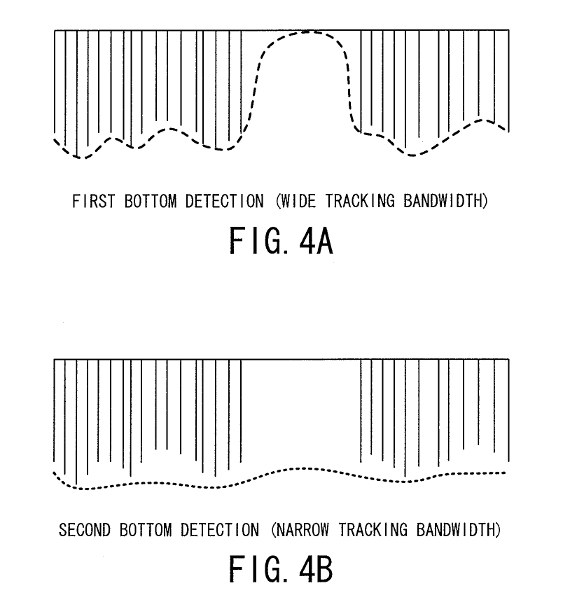

The first bottom-envelope detection circuit 39 has a tracking bandwidth that tracks both a signal portion and a no-signal portion of a BCA waveform signal (see FIG. 4A), while the second bottom-envelope detection circuit 41 has a tracking bandwidth that holds a bottom level of the entire BCA waveform signal (see FIG. 4B). A no-signal-portion detection circuit 43 detects a no-signal portion using the results of the three types of envelope detection described above. A slice-level detection circuit 45 determines a slice level using a no-signal-portion detection signal and a disc-type detection signal, as well as the results of the three types of envelope detection described above. Then, the BCA waveform signal delayed by the delay circuit 53 is binarized by a BCA binarization circuit 55 at the slice level determined by the slice-level detection circuit 45. The BCA binarization circuit 55 sends the binarized signal to a BCA decoder 57 located downstream thereof. The reason why the no-signal-portion detection is performed during the process is to prevent, in a no-signal portion, noise to be erroneously detected as a BCA signal. Such erroneous detection often occurs particularly in a DVD-ROM and a DVD-RAM where modulated data (user data) is superimposed on a no-signal portion in the BCA.

The defect detection circuit 47 detects a defect by using the results of the three types of envelope detection, that is, by using a peak detection value, a first bottom detection value, and a second bottom detection value (described below) and sends a defect detection signal to an MPU 51. According to the defect detection signal from the defect detection circuit 47, the MPU 51 changes a pull-in bandwidth of the preamplifier 25 located upstream thereof to suppress variations in DC level.

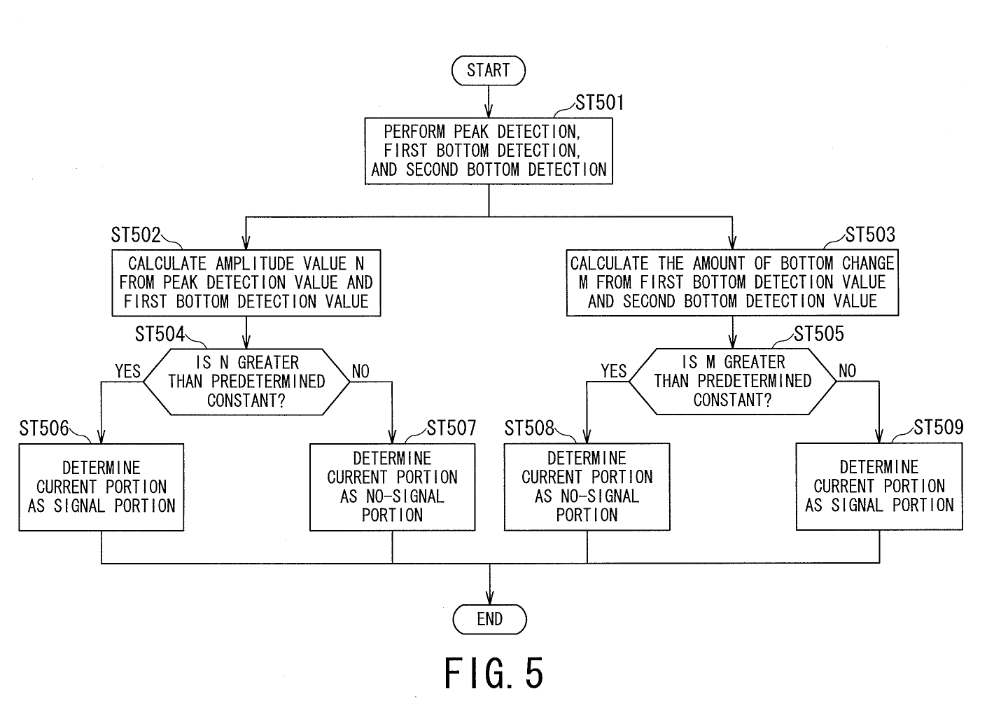

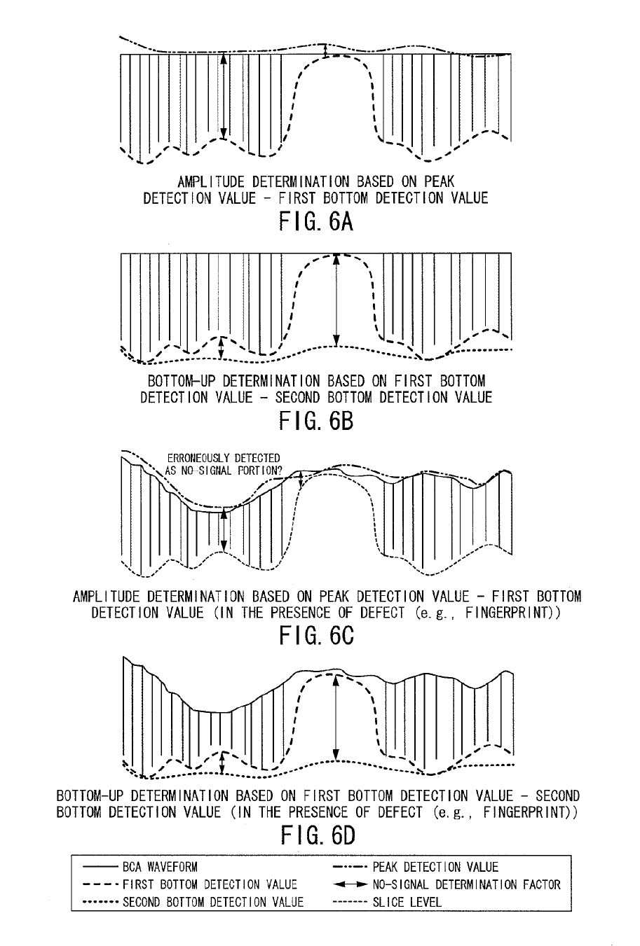

Next, a no-signal-portion detection method will be described with reference to FIG. 5, FIG. 6A, and FIG. 6B. FIG. 5 is a flowchart of processing for detecting a no-signal portion. FIG. 6A illustrates an amplitude determination based on the peak detection value and the first bottom detection value. FIG. 6B illustrates a bottom-up determination based on the first bottom detection value and the second bottom detection value.

First, from the BCA waveform signal, three types of envelope detection are performed for obtaining a peak envelope detection value (hereinafter referred to as peak detection value), a first bottom envelope detection value (hereinafter referred to as first bottom detection value), and a second bottom envelope detection value (hereinafter referred to as second bottom detection value) (step ST501). Next, the no-signal-portion detection circuit 43 subtracts the first bottom detection value from the peak detection value to give an amplitude value N of the BCA waveform signal (step ST502). The no-signal-portion detection circuit 43 determines whether the amplitude value N is greater than a predetermined value (step ST504). If it is determined in step ST504 that the amplitude value N is greater than the predetermined value, the no-signal-portion detection circuit 43 determines that the current portion is a signal portion, where the amplitude is large (step ST506). On the other hand, if it is determined in step ST504 that the amplitude value N is smaller than the predetermined value, the no-signal-portion detection circuit 43 determines that the current portion is a no-signal portion, where the amplitude is small (step ST507). FIG. 6A illustrates the determination of a no-signal portion on the basis of the amplitude.

Meanwhile, in step ST503, the no-signal-portion detection circuit 43 subtracts the second bottom detection value from the first bottom detection value to give the amount of bottom change M (step ST503). The amount of bottom change M indicates to what extent the bottom level has been changed from the bottom level of the entire BCA to the current bottom level. Then, the no-signal-portion detection circuit 43 determines whether the amount of bottom change M is greater than a predetermined value (step ST505). If it is determined in step ST505 that the amount of bottom change M is greater than the predetermined value, the no-signal-portion detection circuit 43 determines that the current portion is a no-signal portion, since it is regarded that the amount of change in bottom level is large, that is, the amplitude is reduced. On the other hand, if it is determined in step ST505 that the amount of bottom change M is smaller than the predetermined value, the no-signal-portion detection circuit 43 determines that the current portion is a signal portion, since it is regarded that there is no significant change in bottom level, that is, there is no change in amplitude. FIG. 6B illustrates the determination of a no-signal portion on the basis of the amount of change in bottom level.

Next, a defect detection method will be described with reference to FIG. 6C, FIG. 6D, and FIG. 9. FIG. 6C illustrates an amplitude determination based on the peak detection value and the first bottom detection value. FIG. 6D illustrates a bottom-up determination based on the first bottom detection value and the second bottom detection value. FIG. 9 is a flowchart illustrating defect detection.

When the amount of reflected light is reduced due to the presence of a defect, such as a fingerprint, the amplitude is reduced as illustrated in FIG. 6C and FIG. 6D. When the amplitude value N is reduced in these waveforms, a portion which is not a no-signal portion may be erroneously determined to be a no-signal portion, and omission of detection may occur. As for the amount of bottom change M, on the other hand, the presence of a defect does not cause a change in bottom level and the defect portion is not erroneously determined to be a no-signal portion. Therefore, the defect detection circuit 47 calculates the amplitude value N from the peak detection value and the first bottom detection value (step ST901) and determines whether the calculated amplitude value N is less than or equal to a predetermined constant “a” (step ST902). If it is determined that the calculated amplitude value N is less than or equal to the predetermined constant “a” (Yes in step ST902), the defect detection circuit 47 calculates the amount of bottom change M from the first bottom detection value and the second bottom detection value (step ST903). Then, the defect detection circuit 47 determines whether the calculated amount of bottom change M is less than or equal to a predetermined constant “b” (step ST904). If it is determined that the calculated amount of bottom change M is less than or equal to the predetermined constant “b” (Yes in step ST904), the defect detection circuit 47 outputs a defect detection signal indicating the presence of a defect (step ST905). If “No” in step ST902 or step ST904, the processing ends.

That is, the defect detection circuit 47 determines that there is a defect if the amplitude value N is less than or equal to the predetermined constant “a” and the amount of bottom change M is less than or equal to the predetermined constant “b”. Therefore, it is possible to prevent omission of detection (erroneous detection of a no-signal portion) due to the presence of a defect.

Additionally, according to a detected defect signal sent from the defect detection circuit 47, the MPU 51 changes a filter coefficient of the preamplifier 25 located upstream thereof and changes a pull-in bandwidth. This makes it possible to suppress variations in DC level.

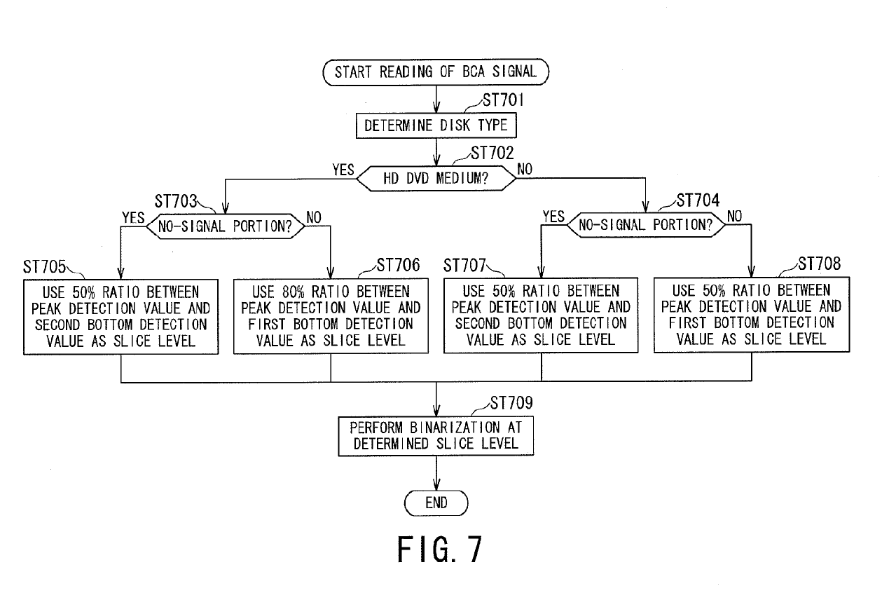

Next, a method for determining a slice level will be described with reference to FIG. 7. FIG. 7 is a flowchart of slice level determination processing.

First, the disc-type determination circuit 49 receives a signal from the ADC 27 and determines the type of the disc (step ST701). Then, the disc-type determination circuit 49 sends the result of the determination to the slice-level detection circuit 45. For example, if the disc-type determination circuit 49 determines that the disc is an HD DVD medium (Yes in step ST702), the disc-type determination circuit 49 informs the slice-level detection circuit 45 that the disc is an HD DVD medium. The slice-level detection circuit 45 determines whether the currently detected portion is a no-signal portion (step ST703). This determination is made by using the result obtained by the no-signal-portion determination method described above.

If the slice-level detection circuit 45 determines that the currently detected portion is a no-signal portion (Yes in step ST703), the level at which the ratio of the second bottom detection value to the peak detection value is 50 percent is determined to be a slice level. The BCA binarization circuit 55 binarizes the BCA signal on the basis of the slice level determined by the slice-level detection circuit 45 (step ST705). In other words, the center of the amplitude of the entire BCA is used as a slice level. In a no-signal portion, a slice level is lowered to prevent erroneous detection due to the presence of noise or the like.

On the other hand, if the slice-level detection circuit 45 determines that the currently detected portion is not a no-signal portion (No in step ST703), the level at which the ratio of the first bottom detection value to the peak detection value is 80 percent (i.e., a level closer to the peak) is determined to be a slice level. The BCA binarization circuit 55 binarizes the BCA signal on the basis of the slice level determined by the slice-level detection circuit 45 (step ST706). In other words, a value near the peak of momentary BCA amplitude is used as a slice level. Here, the slice level is set to a value near the peak because it is possible, in HD DVD specifications, that the amplitude ratio is attenuated by an average of 80 percent. In the case of an HD DVD disc, modulated data (noise) is not superimposed on the BCA signal. Therefore, erroneous detection can be prevented by filtering out a broad spectrum of noise.

The processing returns to step ST702. If the disc-type determination circuit 49 determines that the disc is not an HD DVD medium (No in step ST702), the disc-type determination circuit 49 informs the slice-level detection circuit 45 that the disc is a DVD medium. The slice-level detection circuit 45 determines whether the currently detected portion is a no-signal portion (step ST704). As is the case with the determination described above, this determination is made by using the result obtained by the no-signal-portion determination method described above.

If the slice-level detection circuit 45 determines that the currently detected portion is a no-signal portion (Yes in step ST704), the level at which the ratio of the second bottom detection value to the peak detection value is 50 percent is determined to be a slice level. The BCA binarization circuit 55 binarizes the BCA signal on the basis of the slice level determined by the slice-level detection circuit 45 (step ST707). In other words, the center of the amplitude of the entire BCA is used as a slice level. As is the case with the HD DVD medium described above, in a no-signal portion, the slice level is lowered to prevent erroneous detection due to the presence of noise or the like.

On the other hand, if the slice-level detection circuit 45 determines that the currently detected portion is not a no-signal portion (No in step ST704), the level at which the ratio of the first bottom detection value to the peak detection value is 50 percent is determined to be a slice level. The BCA binarization circuit 55 binarizes the BCA signal on the basis of the slice level determined by the slice-level detection circuit 45 (step ST708). In other words, a value at the center of momentary BCA amplitude is used as a slice level. This is because it is possible in DVD specifications that the amplitude ratio is attenuated by an average of 50 percent, and also because if a value on the peak side is used as a slice level, the presence of modulated data superimposed on the BCA signal causes erroneous detection. Thus, binarization is performed at slice levels determined according to the four patterns described above (step ST709) and thus the processing ends.

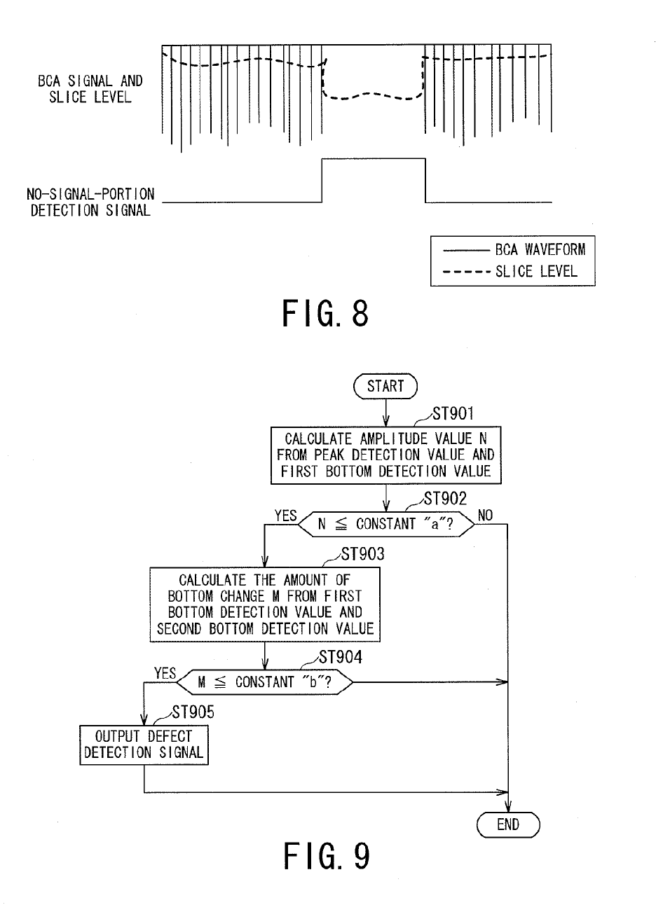

FIG. 8 illustrates an example in which a slice level is changed by the slice level determination method described above. FIG. 8 illustrates a BCA waveform signal, a slice level (indicated by a dotted line), and a no-signal-portion detection signal (indicated by a rectangular wave) when a signal portion, a no-signal portion, and a signal portion are arranged in this order on an HD DVD medium. A low level (0) and a high level (1) of the no-signal-portion detection signal correspond to a signal portion and a no-signal portion, respectively.

In a signal portion, a value on the peak side (i.e., the level at which the ratio of the first bottom detection value to the peak detection value is 80 percent) is used as a slice level. In a no-signal portion, the center of the amplitude of the entire BCA waveform (i.e., the level at which the ratio of the second bottom detection value to the peak detection value is 50 percent) is used as a slice level.

As described above, the results of two types of bottom envelope detection are used in the present invention. This makes it possible to avoid erroneous detection in a no-signal portion of a BCA, allow a distinction between a no-signal portion and a portion where the amplitude is attenuated due to the presence of a fingerprint or the like, and deal with noise that is specific to each disc (e.g., HD DVD or DVD). Moreover, since the present invention makes it possible to achieve detection with less noise at the stage of binarization of a BCA signal, erroneous decoding at a later stage can be avoided.

Next, a modification of no-signal-portion determination will be described with reference to FIG. 5.

FIG. 5 illustrates processing in which the amplitude value N and the amount of bottom change M are compared with respective predetermined constants (in step ST504 and step ST505) to determine whether the current portion is a no-signal portion. However, this determination may be made on the basis of the ratio between N and M. For example, the current portion may be determined to be a no-signal portion if the ratio of the amplitude value N to the amount of bottom change M (N:M) is below 2:8 or 25 percent.

Alternatively, this determination may be made on the basis of the ratio between the amplitude value N shown in FIG. 5 and a value L. This value L is obtained by subtracting the second bottom detection value from the peak detection value and is substantially equal to mean amplitude in the BCA. That is, the no-signal-portion determination may be made on the basis of the ratio between the mean amplitude value L and the momentary amplitude value N. For example, the current portion may be determined to be a no-signal portion if the ratio of the momentary amplitude value N to the mean amplitude value L (N:L) is below 2:10 or 20 percent.

As shown in FIG. 5, the no-signal-portion determination is made on the basis of either the BCA amplitude or the amount of change in bottom level. When the no-signal-portion detection circuit 43 finally sends the results of no-signal-portion determination to the slice-level detection circuit 45, the no-signal-portion detection circuit 43 may select the results (obtained in step ST506 and step ST507) based only on the BCA amplitude or the results (obtained in step ST508 and step ST509) based only on the amount of change in bottom level. Alternatively, it is possible to use the results obtained by ORing or ANDing the results based on the BCA amplitude and the amount of change in bottom level.

Next, a modification of the method for determining a slice level will be described with reference to FIG. 7.

As shown in FIG. 7, two bottom-to-peak ratios of 50 percent and 80 percent only are used to determine a slice level. However, the ratios are not limited to these two, and other ratios, such as 60 percent, 70 percent, 75 percent, and 90 percent may be used.

Alternatively, a slice level may be changed in a stepwise manner every time the no-signal-portion detection signal rises. For example, first, the level at which the ratio of the first bottom detection value to the peak detection value is 10 percent (i.e., a level closer to the bottom) is used as a slice level. Then, every time the no-signal-portion detection signal rises, this ratio is increased by 10 percent. Changing the slice level at every rise of the no-signal-portion detection signal is equivalent to changing the slice level at every rotation of the disc. Since thus error correction is performed on the result of reading of BCA at every slice level for the disc, a result at the optimum slice level can be used.

Next, a modification of the defect detection method will be described.

In the defect detection method described above, the BCA amplitude value N and the amount of bottom change M are compared with respective predetermined constants. However, defect detection may be made on the basis of the ratio between the amplitude value N and the BCA mean amplitude value L and the ratio between the amount of bottom change M and the mean amplitude value L. For example, if the ratio of the amplitude value N to the mean amplitude value L is less than or equal to 20 percent and the ratio of the amount of bottom change M to the mean amplitude value L is less than or equal to 20 percent, it can be determined that there is a defect.

As for the disc-type determination of FIG. 7, a determination as to whether the disc is an HD DVD is made. However, other options, such as ROM, R, RW, and RAM discs, may be added to this, and different slice levels may be set for these discs.

The present invention is not limited to the embodiments described above and can be variously modified within the scope of the invention in a practical phase. The above-described embodiments may be implemented in combination wherever possible, and combined effects can be achieved in such a case. The above-described embodiments contain the invention of various phases, and various embodiments of the invention can be extracted by appropriately combining a plurality of disclosed components.

What is claimed is:

1. A disc apparatus for reading a burst cutting area signal from a disc on which a burst cutting area is formed, the disc apparatus comprising:
a peak-envelope detection circuit configured to detect a peak value of the burst cutting area signal;
a first bottom-envelope detection circuit configured to detect a first bottom value of the burst cutting area signal;
a second bottom-envelope detection circuit having a tracking bandwidth narrower than that of the first bottom-envelope detection circuit, and being configured to detect a second bottom value of the burst cutting area signal;
a detection circuit configured to detect a signal indicating whether a current portion is a no-signal portion, where the burst cutting area signal is not recorded, or a signal portion, where the burst cutting area signal is recorded, on the basis of the peak detection value detected by the peak-envelope detection circuit, the first bottom detection value detected by the first bottom-envelope detection circuit, and the second bottom detection value detected by the second bottom-envelope detection circuit;
a slice-level determination circuit configured to determine a slice level for binarizing the burst cutting area signal on the basis of the signal detected by the detection circuit and at least the peak detection value, the first bottom detection value, and the second bottom detection value; and
a binarization circuit configured to binarize the burst cutting area signal on the basis of the slice level determined by the slice-level detection circuit.

2. The disc apparatus according to claim 1, wherein, during detection, the first bottom-envelope detection circuit is configured to track along a bottom side of the burst cutting area signal and to track at a high level in the no-signal portion where the burst cutting area signal is not present.

3. The disc apparatus according to claim 1, wherein the second bottom-envelope detection circuit has a tracking bandwidth narrower than that of the first bottom-envelope detection circuit and does not track at a high level even in the no-signal portion where the burst cutting area signal is not present.

4. The disc apparatus according to claim 1, wherein the detection circuit is configured to detect the no-signal portion based on a first difference between the peak detection value and the first bottom detection value, a second difference between the first bottom detection value and the second bottom detection value, a ratio between the first and second differences, or a ratio between the first difference and a third difference between the peak detection value and the second bottom detection value.

5. The disc apparatus according to claim 1, further comprising a defect detection circuit configured to detect a defect from a first difference between the first bottom detection value and the second bottom detection value or from a ratio between the first difference and a second difference between the peak detection value and the first bottom detection value.

6. The disc apparatus according to claim 1, further comprising:
a disc-type determination circuit configured to determine a disc type on the basis of the burst cutting area signal from the disc, wherein the slice-level detection circuit changes the slice level according to a result of the determination made by the disc-type determination circuit.

7. The disc apparatus according to claim 1, wherein the slice-level detection circuit is configured to use a no-signal-portion detection signal from the detection circuit to change the slice level in a stepwise manner at every rotation of the disc.

8. A burst cutting area signal reproduction method for reading a burst cutting area signal from a disc on which a burst cutting area is formed, the method comprising:
detecting a peak value of the burst cutting area signal;
detecting a first bottom value of the burst cutting area signal using a wide tracking bandwidth;
detecting a second bottom value of the burst cutting area signal using a narrow tracking bandwidth;
detecting a signal indicating whether a current portion is a no-signal portion, where the burst cutting area signal is not recorded, or a signal portion where the burst cutting area signal is recorded, on the basis of the detected peak detection value, the first bottom detection value detected using the wide tracking bandwidth, and the second bottom detection value detected using the narrow tracking bandwidth;
determining a slice level for binarizing the burst cutting area signal on the basis of the detected signal and at least the peak detection value, the first bottom detection value, and the second bottom detection value; and
binarizing the burst cutting area signal on the basis of the determined slice level.

9. The burst cutting area signal reproduction method according to claim 8, wherein detecting the first bottom value comprises tracking a bottom side of the burst cutting area signal during a signal portion of the burst cutting area signal, and tracking a high level side of the burst cutting area signal during a no-signal portion.

10. The burst cutting area signal reproduction method according to claim 8, wherein the tracking bandwidth for the second bottom detection value is narrower than that for the first bottom detection value, and wherein detecting the second bottom value comprises not tracking a high level side of the burst cutting area signal even in the no-signal portion.

11. The burst cutting area signal reproduction method according to claim 8, further comprising detecting the no-signal portion from a first difference between the peak detection value and the first bottom detection value, a second difference between the first bottom detection value and the second bottom detection value, a ratio between the first and second differences, or a ratio between the first difference and a third difference between the peak detection value and the second bottom detection value.

12. The burst cutting area signal reproduction method according to claim 8, further comprising detecting a defect from a first difference between the first bottom detection value and the second bottom detection value or from a ratio between the first difference and a second difference between the peak detection value and the first bottom detection value.

13. The burst cutting area signal reproduction method according to claim 8, further comprising:
determining a disc type on the basis of the burst cutting area signal from the disc, wherein the slice level is changed according to the determined disc type.

14. The burst cutting area signal reproduction method according to claim 8, further comprising using a no-signal-portion detection signal to change the slice level in a stepwise manner at every rotation of the disc.
